(19) United States
(12) Patent Application Publication
(10) Pub. No.: US 2006/0027515 A1
(43) Pub. Date: Feb. 9, 2006

(54) Multi-positionable ham holder

(76) Inventors: Antonio Tomas Martinez, La Canada Paterna (Velencia) (ES); Pascual Tomas Martinez, Valencia (ES)

Correspondence Address: RICHARD M. GOLDBERG, 25 EAST SALEM STREET, SUITE 419, HACKENSACK, NJ, 07601, US

(21) Appl. No.: 11/197,084

(22) Filed: Aug. 4, 2005

(30) Foreign Application Priority Data
Aug. 4, 2004 (ES) U 2004 01947

(51) Int. Cl. B42F 13/12; A47F 5/14

(52) U.S. Cl. 211/181.1; 211/125

(57) ABSTRACT

A multi-positionable ham holder includes an arrangement for holding the leg of a ham, conveniently a pressure screw and an arrangement for supporting the thicker part of the ham, which includes, a support structure able to be installed on a horizontal or vertical surface, a securing part set in the support structure, bars which have a concave-curved shape and which have at their ends an arrangement for securing the leg of the ham and for sticking in the opposite end of this. These bars are able to run along the securing part, and further including a mechanism for releasing/securing the bars in respect of the securing part.

The technical field involved in this invention is that of ham holders or clamps, of the sort that secure the leg of ham in order to facilitate cutting the slices of cured meat in the best way to ensure the user's convenience, both in the tasks of slicing the ham and for cleaning and preparing the side parts to remove the fat, rind, etc.

### PRIOR STATE OF THE ART

ES 1032773 for a ham holder with a structure consisting of two parallel triangles between which there is a frame and which has a guide holding a support that can be moved along said guide with a clamp attachment for the ham.

ES2190693 for an articulated and rotatable ham holder, with a rotatable part held on the vertical frame or base which holds the ham, and which can be set in different angular positions and lock the rotatable part at the front or the rear of the inner bushing.

ES2178949 for a rotatable ham holder, consisting of a structure with a double support, both parts joined to the base, so as to have a securing piece for the thicker part of the ham, which is rotatable and fitted with a cross-piece and a central spike, and a securing piece for the leg, similarly rotatable after the securing screw has been released.

ES2167169 for a ham holder which includes a rotatable circular part at one end of the frame and another also rotatable at the opposite end, the first for the leg and the second in pincer shape for the thicker end. The rotatable item emerges from a mast and has a tightening part for locking rotation and a mechanism for locking the leg in the rotatable device.

ES1057085 for a retaining arrangement for multi-positioning of hams and shoulders, consisting of a rotatable head provided with two tightening screws which hold the leg, set on one rotatable circle on another connected to a support.

ES 1048244 for an improved ham holder, consists of a support structure forming two columns, one for supporting the shoulder part in a “V” shape and another formed of a circle fitted with two adjustments, one for rotation and another for pressure on the leg, this one being able to adopt a selectable tilt or an appropriate elevation.

ES1030492 for an improved ham holder, consists of a base which has a dual telescopic bar whose ends emerge and sustain two securing devices; one for the leg, with a support set in a rotatable medium and another, also set in a rotatable medium, for the thicker part, the latter being fitted with two pairs of jaws.

ES 1028640 for an improved ham holder consists of a base from which a frame emerges, holding a dual concentric rotatable ring fitted with two screws, one at one end of the ring and another at the part next to this.

The object of this invention is a Multi-positionable ham holder, appropriate for being placed on the wall as well as on a table top, fitted with a device for holding the leg and a device for moving the body of the ham along a curved guide which determines different orientations and different inclinations of the whole assembly, which is released or fixed by means of a single lever, so as to allow any kind of intervention for cutting this with a ham knife, at the same time as enabling the user to continuously modify the position of the ham in respect of the support if the cut requires this.

In order to make the following explanation clearer, five sheets of drawings are enclosed representing the essence of this invention in eight figures.

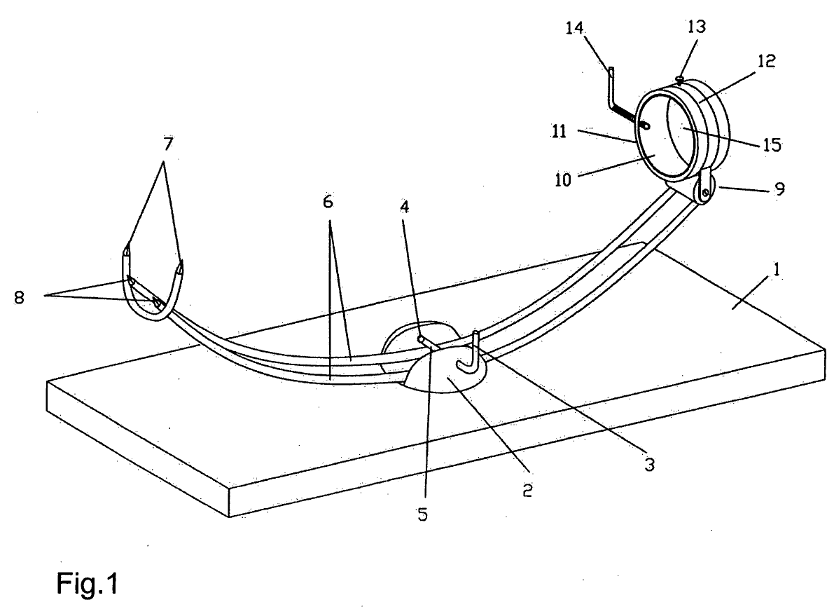

FIG. 1 shows a view of the ham holder as a whole

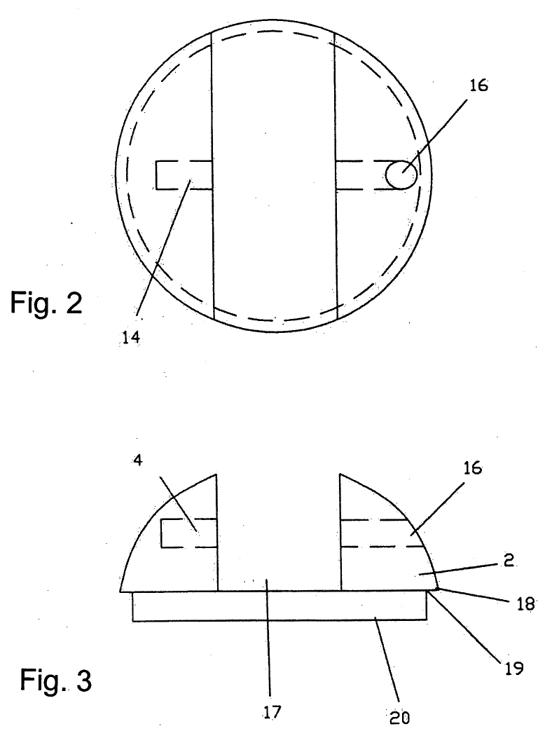

FIG. 2 shows a view of the securing base from above

FIG. 3 shows a view of the securing base in elevation

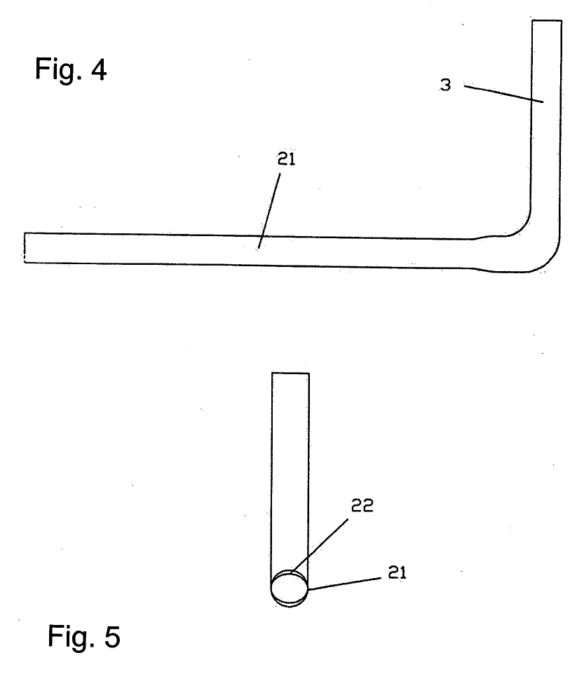

FIG. 4 shows a view of the securing bar

FIG. 5 shows a detail of the securing bar

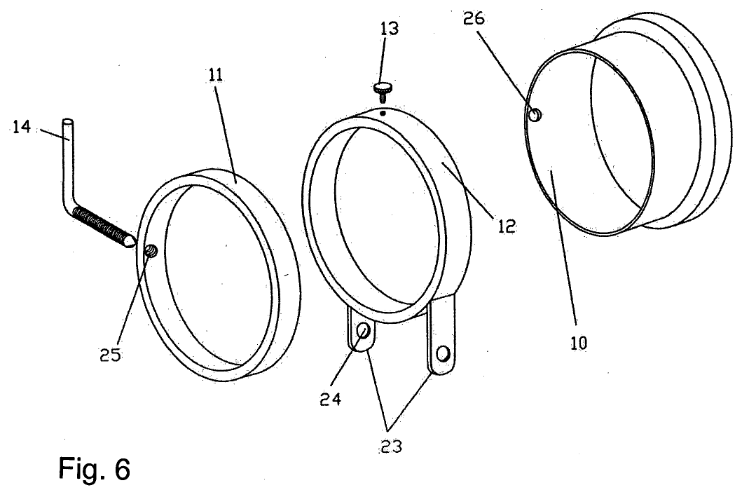

FIG. 6 shows an exploded view of the rotatable device

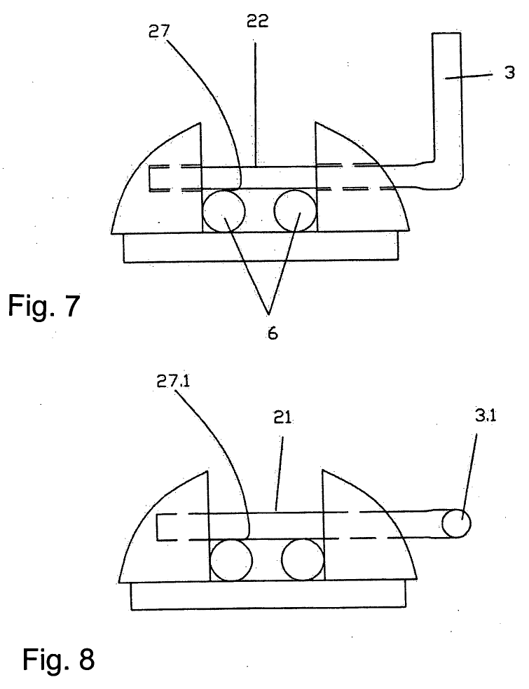

FIG. 7 shows a view of the securing base with the bars of the ham holder and the securing bar in released position.

FIG. 8 shows a view of the securing base with the ham holder bars and the securing bar set in a locked position.

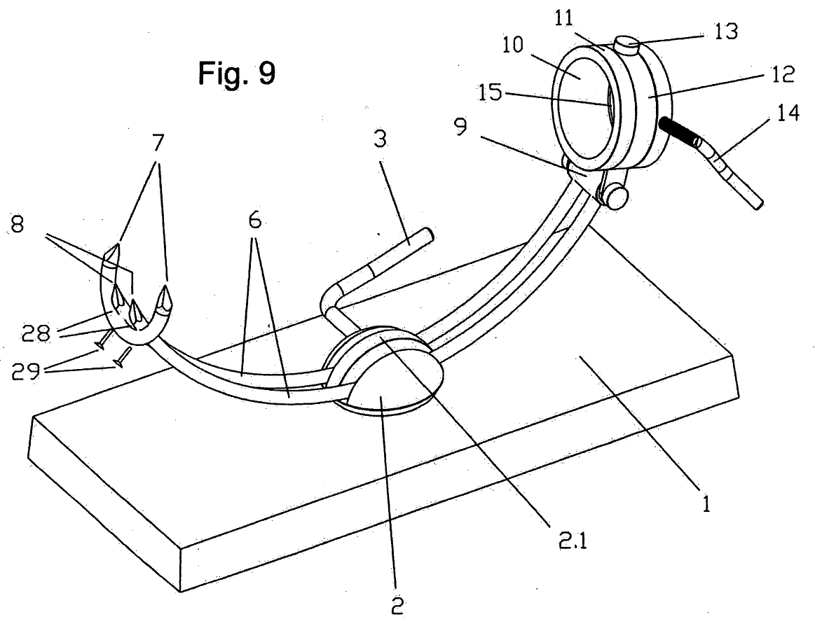

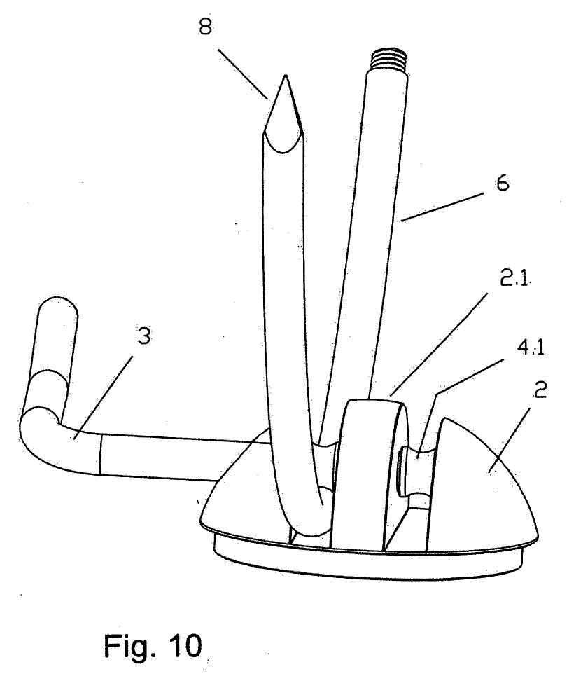

FIG. 9 shows a view of the assembly, provided with a central reinforcement.

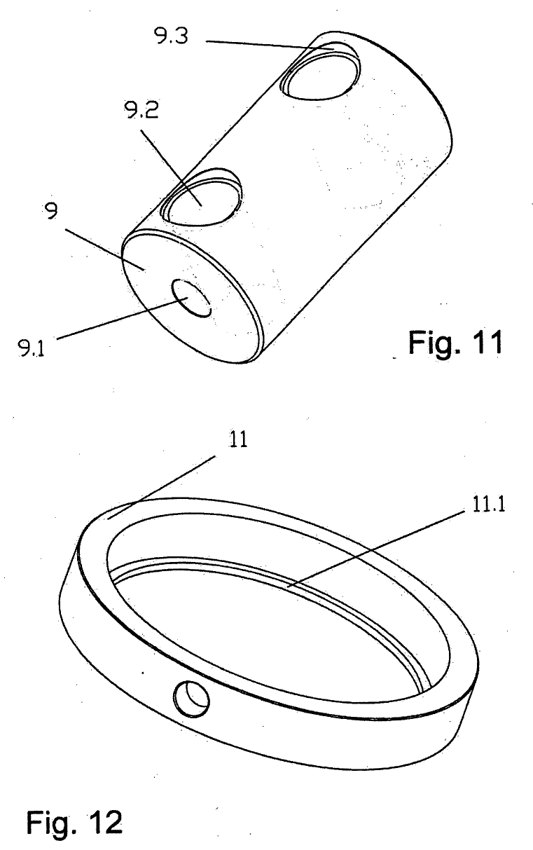

FIG. 10 shows a detail of the central reinforcement.

FIG. 11 shows a detail of a piece of variable inclination.

In said figures the following items are represented by the numbers:
1 ham holder support structure, consisting of a regular or irregular piece of material, with decorations or without these
2 securing part for the bars 6 of the ham support
2.1 central part of the securing part which receives the bars 6 in its sides and fixes them in such position
3 securing lever for holding the bars 6 to the securing item 2
3.1 is the position of the lever in locking position
4 hole where the lever is inserted in the securing item 2
4.1 socket-guide; receives the eccentric by its interior and its surface, mainly coincident with the profile of the pieces 6, helps the fixation
5 eccentric central part of the securing item
6 bars for supporting the ham
7 spikes at the end of the bars
8 spikes at the end of the bar facing outwards
9 coupling between the bars 6 and the part for joining to the leg
9.1 holes for the articulation of the rotatable device
9.2 holes for passing the bars through
9.3 external lips of the holes 9.2
10 rotatable body
11 external ring, connected to the body 10
11.1 narrowing flange produced in the external ring 10, avoids to be introduced in excess and that undesired friction to be produced with the neighbour part 12
12 central ring, joined to the coupling 9
13 securing screw between the central ring 12 and the rotatable body 10. The pressure on the screw holds both together
14 lever of the securing screw for the leg
15 hollow for inserting the leg
16 hole through which the securing item is inserted, and in particular the eccentric part 5
17 lower part of the securing part 2 which acts as a support for the support bars 6
18 angle of the securing item 2
19 projection of the lower part of the securing part 2; this is inserted in the structure 1 with the function of preventing dust or dirt from getting into said base 2
20 lower part of the base 2, that can be held to the structure 1 by means of screws or adhesive
21 eccentric part of the bar 5; larger radius of the eccentric item
22 shape of the eccentric part of the bar 5; lesser radius of the eccentric part
23 securing tabs between the bars 6 and the coupling 9 of the central ring 12
24 holes for securing in the tabs 23
25 way through for the lever 14 in the external ring 11
26 way through for the lever 14 in the rotatable body 10
27 gap between the bars 6 and the central part 5 of the lever 3 in its eccentric position 22
27.1 pressure between the bars 6 and the central part 5 of the lever 3 in its eccentric position 21.
28 coplanar recess between the bars 6 and the part with the spikes 7
29 screws for the fixation of the coplanar parts in 28

### Explanation of One Form of Embodiment

The structure 1 constitutes a heavy and tough means of support for table-top use. The securing item 2 is arranged so that its edge drops at an angle 18, fitting perfectly onto the surface 1 so that this does not accumulate dirt, or is at least easily cleanable. The lower part of the base 20 is able to be held by means of screws at the bottom, by adhesive or both to the hollow made in the support structure 1.

Said securing part can be installed in any position and carry out the function, either as support structure 1 fixed to the wall, or set on a table top.

The securing part 2 has a lower part 17 which constitutes the support of the bars for holding the ham 6, so that these bars, which are curved, enable it to be set at any point along the ham. This makes it easier for the user to place the leg in a higher position, the thicker part in a higher position and any intermediate position.

The device for securing the support bars 6 to the securing item 2 consists of a bore in item 2, a through hole 16 and a further blind one 4, set at a height in respect of the lower part 17, adjusted to the height or thickness of the bars 6. In said holes it has a lever 3 which is formed of an “L” shaped part with an eccentric part 5. This eccentricity allows the part with greater diameter 21 to be the one that engages against the bars, insofar as the part with lower diameter 22 is the one that allows the bars to remain free and thus able to move. To move any distance it may be preferable to remove the lever 3. The form of securing them is appreciated in FIG. 7, releasing position, and in FIG. 8 the securing position, depending on the position 3.1 of the lever.

The device for turning and securing the leg consists of a part 12 which is fixed and has a ring, tabs 23 and in these holes 24 for securing them in the coupling 9. This ring 12 is inserted in a rotatable body 10, which has a recess along which the ring is fitted. Said rotatable body 10 also has a third ring 11 fitted with a lever 14 with a securing screw, which is inserted in its hole 25 coinciding with the hole 26 of the rotatable body 10. In this way the ring 12 is blocked between the body 10 which is rotatable and the external ring 11 which is held to the former by holes 25 and 26, and thus to the leg of ham.

The central ring 12 is therefore free. It can nevertheless be fixed by means of a small manual screw 13 which exerts pressure on any part of the rotatable body 10, so that simple manual pressure fixes or releases the rotation of the ham whose leg is held by the screw of the lever 14.

The ham can thus take any position in respect of the base. One end of the bars 6 is fitted with spikes in two directions: a set of two spikes angled roughly perpendicularly to the position of the bars 6 and others set along this, and as pointed end of these.

A central reinforcement 2.1 has been previewed which is set between the two external walls of the securing part 2, in such a way that it avoids the displacement of the bars 6, approaching to each other, when they are pressed by the eccentric. The pressure is also exerted by means of the socket-guides 4.1 which have a shape adapted to the profile of said bars 6, in such a way that they exert a pressure on a large common surface, so with a small effort an optimal immobilization is achieved.

The rotatable device has an external ring 11 having a flange 11.1; This facilitates that this part do not reach to friction with central ring 12, since it cannot be displaced to said ring 12, in such a way that it remains free to rotate avoiding any contact with the ring 12. The flange is placed in the external part of said ring 11.

The spikes at the end of the bars placed on a body with approximately “U” shape have a shape coplanar 28 with the bars 6, in such a way that it can be secured by means of at least a fixing screw, avoiding any welding, and being the screw placed in the lower part so it is not visible.

The part 9 of insertion of the end of the bars 6 in the articulation of variable inclination which holds the rotatable part avoids the welding, which produces a bad esthetical effect, and while enhancing the aesthetics, helps the assembling of the bars and the articulation of variable inclination in the ends of 9. Thus, the union between the bars 6 and the rotatable part which holds the leg is constituted by the piece which articulates the rotatable head in the opposite holes 9.1 so it is a swivel of variable inclination, and holes 9.2 for passing the bars 6 through them with external lips 9.3 in the external part of said holes 9.2, in such a way that each of the bars are inserted without welding.

This is for industrial application in making ham holders.

What is claimed is:

1. Multi-positionable ham holder for holding a leg of a ham, comprising:
a support structure adapted to be installed on a horizontal or vertical surface;
a securing part set in said support structure;
bars which have a concave-curved shape and which have at ends thereof, an arrangement for securing a leg of a ham by sticking into an end of said ham, said bars being adapted to run along said securing part; and
a mechanism for releasing/securing the bars in respect of the securing part.

2. A Multi-positionable ham holder, according to claim 1, wherein the securing part includes an acute outer edge and a lower part slightly withdrawn in respect of said edge, which marks out a separation of the lower part of said part.

3. Multi-positionable ham holder, according to claim 2, wherein the support structure has a recess corresponding to the lower part of the securing part, so that the lower part of the securing part is inserted and secured in said recess.

4. Multi-positionable ham holder, according to claim 1, wherein the securing part has a blind hole and a through-hole each located in alignment with the other.

5. Multi-positionable ham holder, according to claim 4, wherein the mechanism for releasing/securing the bars in respect of the securing part includes:
a lower part of the securing part which supports the bars, and
a lever having an eccentric central part extending across the lower part of the securing part and extending through the blind and through holes in order to press or release the bars by pressure from the eccentric central part, in which the eccentricity of said eccentric central part is formed of an oval arrangement of said central part, so that the eccentric central part has a larger radius and a lesser radius.

6. Multi-positionable ham holder, according to claim 1, wherein one end of the bars is fitted with spikes, and a part having spikes is secured to said proximate end of said bars in a manner which is substantially perpendicular to said bars.

7. Multi-positionable ham holder, according to claim 1, further comprising:
a coupling at one end between the bars,
a central ring including fixing tabs endowed with holes for receiving said coupling,
a rotatable body with an edge which is concentric with said central ring and on which said central ring is mounted, the rotatable body including a hole, and
a further ring which is set to an opposite side of the ring and which is mounted on the rotatable body, the further ring including a threaded hole in alignment with the hole in the rotatable body,
a lever threadedly engaged in said threaded hole and said hole in said rotatable body for rotatable locking said rotatable body and said further ring, and
a locking device in the ring formed by at least one securing screw which establishes a pressure from the ring which holds the ring locked with respect to the ring.

8. Multi-positionable ham holder, according to claim 1, further comprising a central reinforcement which is set between two external walls of the securing part, in such a way that displacement of the bars to each other is avoided, when the bars are pressed by an eccentric, this pressure being exerted through socket-guides which have a curved shape adapted to a part of a curve profile of these bars, so that the pressure between the bars and the socket-guides is exerted on a large common surface.

9. Multi-positionable ham holder, according to claim 7, wherein the further ring is a rotatable ring provided with a flange placed at an external part of said rotatable ring, in such a way that said rotatable ring has an axial dimension lower than a distance from said flange to the central ring.

10. Multi-positionable ham holder, according to claim 1, further comprising a body with a “U” shape which has ends that form spikes and which has a coplanar shape with the bars in such a way that the body has a common surface for being secured by at least a securing screw to said bars, without welding, said at least a securing screw placed preferable from a lower part thereof.

11. Multi-positionable ham holder, according to claim 7, wherein:
the coupling for coupling the end of the bars into an articulation of variable inclination which holds the central ring, has opposite holes for varying the inclination and holes for the insertion and securing of the bars.
